(19) United States
(12) Patent Application Publication
(10) Pub. No.: US 2015/0373945 A1
(43) Pub. Date: Dec. 31, 2015

(54) Smart Animal Feeder

(71) Applicant: ZILLIANS INCORPORATED, Taipei (TW)

(72) Inventor: Mu Chi Sung, Taipei (TW)

(73) Assignee: ZILLIANS INCORPORATED, Taipei (TW)

(21) Appl. No.: 14/751,839

(22) Filed: Jun. 26, 2015

Related U.S. Application Data
(60) Provisional application No. 62/017,461, filed on Jun. 26, 2014.

(51) Int. Cl. A01K 5/02; A01K 7/06; A01K 11/00

(52) U.S. Cl. CPC A01K 5/0283; A01K 11/006; A01K 7/06

(57) ABSTRACT

One possible system may include a detector, a food scale, a water scale, a facial camera, and a processor. The detector may recognize a presence or absence the animal. The food scale may determine a weight of food in a food tray. The water scale may determine a weight of water in a water tray. The facial camera may observe a face of the animal when the animal is feeding or drinking. The processor may determine, upon an indication that the animal is present, and the face of the animal observed by the facial camera, an identity of the animal. The processor may additionally determine via the food scale, upon an indication that the animal is absent, an amount of food consumed by the animal. The processor may moreover determine via the water scale, upon an indication that the animal is absent, an amount of water consumed by the animal.

### CROSS-REFERENCE TO RELATED APPLICATIONS

This application claims priority to Provisional U.S. Patent Application No. 62/017,461 filed Jun. 26, 2014, entitled “THE ULTIMATE SMART PET FEEDER FOR HEALTH MONITORING,” entire disclosure of which is hereby incorporated by reference, for all purposes, as if fully set forth herein.

### BACKGROUND OF THE INVENTION

This invention relates generally to pets. More specifically the invention relates to smart systems for feeding pets and assisting in maintaining their health.

### BRIEF DESCRIPTION OF THE INVENTION

In one embodiment, a system for providing food to an animal is provided. The system may include an animal scale, a food tray, a food scale, a water tray, a water scale, a facial camera, and a processor. The animal scale may be for determining a weight of an animal on the animal scale. The food tray may be for receiving food from a food bin. The food scale may be for determining a weight of food in the food tray. The water tray may be for receiving water from a water bin. The water scale may be for determining a weight of water in the water tray. The facial camera may be for observing a face of the animal when the animal is facing at least one of the food tray or the water tray. The processor may be in communication with the animal scale, the food scale, the water scale, and the facial camera. The processor may also be for causing, upon a first change in weight being indicated by the animal scale, activation of the facial camera. The processor may further be for determining, based at least on the face of the animal Observed by the facial camera, an identity of the animal. The processor may additionally be for determining, based upon a second change in weight being indicated by the animal scale, that the animal has left the animal scale. The processor may moreover be for determining, after the animal has left the animal scale, and based at least in part on the food scale, an amount of food consumed by the animal. The processor may furthermore be for determining, after the animal has left the animal scale, and based at least in part on the water scale, an amount of water consumed by the animal. The processor may also be for causing the identity of the animal, the amount of food consumed by the animal, and the amount of water consumed by the animal to be transmitted to a remote device.

In another embodiment, a system for providing food to an animal is provided. The system may include an animal scale, a food tray, a food scale, a water tray, a water scale, a facial camera, and a processor. The animal scale may be for determining a weight of an animal on the animal scale. The food tray may be for receiving food from a food bin. The food scale may be for determining a weight of food in the food tray. The a water tray may be for receiving water from a water bin. The water scale may be for determining a weight of water in the water tray. The facial camera may be for observing a face of the animal when the animal is facing at least one of the food tray or the water tray. The processor may be in communication with the animal scale, the food scale, the water scale, and the facial camera. The processor may also be for causing, upon a first change in weight being indicated by the animal scale, activation of the facial camera. The processor may further be for determining, based at least on the face of the animal observed by the facial camera, an identity of the animal. The processor may additionally be for determining, based upon a second change in weight being indicated by the animal scale, that the animal has left the animal scale. The processor may moreover be for determining, after the animal has left the animal scale, and based at least in part on the food scale, an amount of food consumed by the animal. The processor may furthermore be for determining, after the animal has left the animal scale, and based at least in part on the water scale, an amount of water consumed by the animal.

In another embodiment, a system for providing food to an animal is provided. The system may include a first means, a food scale, a water scale, a facial camera, and a processor. The first means may be for recognizing a presence or an absence of an animal. The food scale may be for determining a weight of food in a food tray. The water scale may be for determining a weight of water in a water tray. The facial camera may be for observing a face of the animal when the animal is facing at least one of the food tray or the water tray. The processor may be in communication with the means for recognizing the presence of the animal, the food scale, the water scale, and the facial camera. The processor may also be for determining, upon a first indication from the first means that the animal is present, and based at least on the face of the animal observed by the facial camera, an identity of the animal. The processor may additionally be for determining, upon a second indication from the first means that the animal is absent, and based at least in part on the food scale, an amount of food consumed by the animal. The processor may moreover be for determining, upon the second indication from the first means that the animal is absent, and based at least in part on the water scale, an amount of water consumed by the animal.

### BRIEF DESCRIPTION OF THE DRAWINGS

The present invention is described in conjunction with the appended figures:

FIG. 1 is an axonometric view of one embodiment of the invention;

FIG. 2 is a system block diagram of the embodiment of the invention from FIG. 1;

FIG. 3 is flow diagram of one method of the invention;

FIG. 4 is a representation of one mobile device display screen which interacts with systems and methods of the invention;

FIG. 5 is an axonometric view of another embodiment of the invention; and

FIG. 6 is a block diagram of an exemplary computer system capable of being used in at least some portion of the apparatuses or systems of the present invention, or implementing at least some portion of the methods of the present invention.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION OF THE INVENTION

The ensuing description provides exemplary embodiments only, and is not intended to limit the scope, applicability or configuration of the disclosure. Rather, the ensuing description of the exemplary embodiments will provide those skilled in the art with an enabling description for implementing one or more exemplary embodiments. It being understood that various changes may be made in the function and arrangement of elements without departing from the spirit and scope of the invention as set forth in the appended claims. For example, any detail, characteristic, method step, or structure discussed with regard to one embodiment may or may not be present in every version of that embodiment. Additionally, any detail, characteristic, method step, or structure discussed with regard to one embodiment may or may not be present in every version of other embodiments. Finally, any detail, characteristic, method step, or structure not discussed herein is understood to be contemplated as not being present in any particular version of any embodiment discussed herein.

Specific details are given in the following description to provide a thorough understanding of the embodiments. However, it will be understood by one of ordinary skill in the art that the embodiments may be practiced without these specific details. For example, circuits, systems, networks, processes, and other elements in the invention may be discussed or shown as components in block diagram form in order not to obscure the embodiments in unnecessary detail. In other instances, well-known circuits, processes, algorithms, structures, and techniques may be discussed or shown without unnecessary detail in order to avoid Obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but could have additional steps not discussed or included in a figure. Furthermore, not all operations in any particularly described process may occur in all embodiments. A process may correspond to a method, a function, a procedure, a subroutine, a subprogram, etc. When a process corresponds to a function, its termination corresponds to a return of the function to the calling function or the main function.

The term “machine-readable medium” includes, but is not limited to, portable or fixed storage devices, optical storage devices, wireless channels and various other mediums capable of storing, containing or carrying instruction(s) and/or data. These mediums may be transitory or non-transitory, depending on the embodiment. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments of the invention may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. One or more processors may perform the necessary tasks.

In one embodiment of the invention, a system for providing food to an animal is provided. The system may allow for an animal to be fed, watered, and their health monitored remotely by a user, perhaps the animal's owner when the animal is a pet or constitutes livestock. Merely by way of example, such animals may be cats, dogs, birds, cattle, horses, reptiles, amphibians, mammals, or other creatures. Though this disclosure shall often refer to a cat being the animal, all other types of animals are also contemplated. The system provides continuously updated information to a user on how much food and water has been consumed, the time periods during which consumption has occurred, and the current weight of the animal in question. This information may be provided from the systems of the invention to a remote device, such as a server, and then delivered to a mobile device (or other device) of a user upon demand. Communication between the system and the remote device and/or mobile device may occur over wired, wireless, telecommunication networks, etc. Alerts may also be pushed to a user's mobile device (or other device) depending on the selected configuration of the systems herein. The system also allows for the consumption of an animal to be influenced via various modes which may be controlled by a user. In any embodiment discussed herein, communications may also occur directly between the processor of the system and a user's mobile or other device, without the use of an intermediate remote device.

Embodiments of the invention may also differentiate between different animals using the system, and track their consumption accordingly. Cameras monitoring the device, as well as differences in weights of different animals, may be used to determine which animal is feeding and drinking from the device, and data regarding their consumption may therefore be stored and evaluated separately to track the habits and health of each separately.

Embodiments of the system may include a means for recognizing a presence or an absence of an animal and/or for determining the animal's weight (for example, an animal scale, and/or other motion sensing/weighing device), a food tray, a food scale, a water tray, a water scale, a facial camera, and/or a processor. The processor, along with any component discussed herein, may be in communication with any other component discussed within this disclosure, either by wired or wireless means, to accomplish any step discussed herein. In some embodiments, a food bin, a water bin, a monitoring camera, a remote device such as a server, a mobile device, a means for causing food from the food bin to be provided to the food tray (for example, a motor and auger, and/or other selectively activate-able valve/agitator device), a means for causing water from the water bin to be provided to the water tray (for example, a valve, and/or other selectively activate-able mechanism), and a guard covering the food and/or water tray may also be provided.

The means for recognizing a presence or an absence of an animal and/or for determining the animal's weight (referred to hereinafter as an “animal scale”) may activate when the animal steps onto the animal scale. The animal scale may be placed relative to other components of embodiments of the invention such that the animal must maneuver onto the animal scale in order to access or reach the food and water provided in the food tray and water tray. In some embodiments, a guard may be provided which covers at least one of the food tray or the water tray. The guard may have an aperture shaped to allow no more than one animal access the food tray or the water tray at a time. In this manner, animal recognition methods discussed herein may work more properly, than without a guard or other device which prevent multiple animals from accessing the food and water at the same time.

The animal scale may determine, possibly with assistance from the processor, a weight of the animal on the scale. This weight may be made to correspond with an identification of the animal as determined by the other devices discussed herein. The corresponding information can then be saved or transmitted to a remote device (i.e., server and/or mobile device) for future reference by the user. In some embodiments, the presence of an animal on an animal scale may cause the processor to initiate or cease any of the functions described herein, for example, activation of the facial camera. Likewise, whenever an animal moves away from the animal scale, removing weight from the animal scale, the processor may initiate or cease any of the functions described herein, for example, sending of data to a remote device and/or mobile device.

The food tray may be for receiving food from a food bin, and thereby make such food available to an animal which desires to feed from the food tray. In some embodiments a means for causing food from the food bin to be provided to the food tray may be activated by the processor to cause food to move from the food bin to the food tray. The means may be activated in response to the processor determining, via the food scale, which measures the weight of the food tray, that a predefined amount of food has been reached (i.e., a weight dropping below a certain threshold), and that the food tray should be replenished. The means may include a motor coupled with an auger, whereby the processor causes the motor to activate, which causes the auger to turn and move food, or allow food to move, from the food bin to the food tray. The food scale may constantly or intermittently weight the food tray to determine the weight of food consumed by the animal, and such food weight may be stored in correspondence with the identity of the animal on at the feeder.

The water tray may be for receiving water from a water bin, and thereby make such water available to an animal which desires to drink from the water tray. In some embodiments a means for causing water from the water bin to be provided to the water tray may be activated by the processor to cause water to move from the water bin to the water tray. The means may be activated in response to the processor determining, via the water scale, which measures the weight of the water tray, that a predefined amount of water has been reached (i.e., a weight dropping below a certain threshold), and that the water tray should be replenished. The means may include a valve, especially an electronically actuated valve, whereby the processor causes the valve to actuate, which causes the water to gravity feed from the water bin to the water tray. The water scale may constantly or intermittently weight the water tray to determine the weight of water consumed by the animal, and such water weight may be stored in correspondence with the identity of the animal on at the feeder.

The facial camera may be for observing a face of the animal when the animal is facing at least one of the food tray or the water tray. The facial camera may serve several functions. First, in conjunction with the processor, the images from the facial camera can be analyzed to determine the identity of the animal that is approaching or at the feeder, perhaps as it begins to feed or drink from the food/water trays. Facial recognition algorithms may be used to compare a currently observed animal to a previously Observed animal to determine if it is the same animal, thereby identifying the animal. Concurrently or alternatively, such algorithms may be used to differentiate the animal from a previously observed animal. In some embodiments, a user may implement an animal registration process with the system via their mobile device, whereby when an animal initially uses the feeder, they inform a mobile application of the identity of the animal (i.e., the animal's name as given by the user). Thereafter, the processor, remote system, and/or mobile device (hereinafter including the mobile application) may recognize when the same animal, as opposed to a different animal, is using the feeder. The identities and appearances of multiple animals which use the feeder may be recorded in this manner.

Secondly, the facial camera may be used to monitor the animal while feeding. In some embodiments, for any particular function of the facial camera, the facial camera may not be activated by the processor unless the animal scale indicates an animal is present. In these and other embodiments, a user, via their mobile device may also be able to activate the facial camera to observe its field of view regardless of whether an animal is feeding. Picture or video data may be transmitted. In some embodiments, alerts may be issued by the processor to the mobile device, informing a user when their animal is feeding, and allow a user to know that activity of the animal on the animal scale usually feeding/watering) may be occurring and thus be viewable at that time. In some embodiments, a microphone and/or speaker may also be provided allowing a user to conduct one or two way communication with the system via their mobile device and or the remote device.

Thirdly, the facial camera may be used to at least assist in determining whether an animal is present at the feeder. In some embodiments, the facial camera may be constantly active, and therefore image data from the facial camera may be able to determine if an animal is present without usage of the animal scale. In other embodiments, the animal scale and/or the facial camera (as well as the monitoring camera), may each be used to verify the presence of an animal if an inconclusive condition is indicated by one of the other devices.

In some embodiments, the system may also include a monitoring camera for observing an amount of food in the food bin and an amount of water in the water bin. The processor may then be able to determine, based at least in part on the amount of food in the food bin or the amount of water in the water bin, whether to transmit an alert to the remote system and/or mobile device informing the user that the food and/or water levels in the bin may be running low. A predefined minimum level of food and/or water may trigger such a process. In some embodiments, as will be discussed further herein, the monitoring camera may be placed opposite the facial camera, perhaps facing each other from opposite sides of the animal scale. In some embodiments, the processor may use images from the monitoring camera to assist in determining the identity of an animal on the animal scale.

Thus, after use of the feeder, the processor may cause the identity of the animal which used the feeder, the weight of the animal, the amount of food consumed by the animal, and/or the amount of water consumed by the animal to be transmitted to the remote device (i.e., a server). The remote device may then store and/or analyze such information to provide it to a user's mobile device. An application or web browser may be used on the mobile device to access such information. The mobile device may include, merely by way of example, a mobile phone, a personal data assistant, a tablet computer, a smart watch, or a facially wearable device such as Google Glass™. Additionally, a user may use an application or web browser on any other electronic device such as a notebook, laptop, terminal, or desktop computer to access such information.

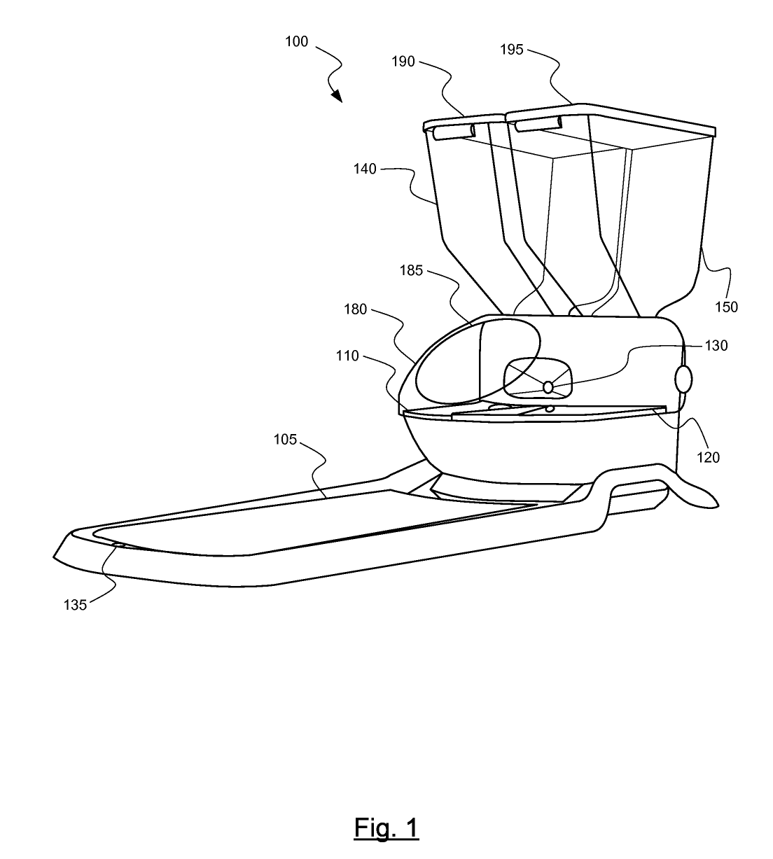

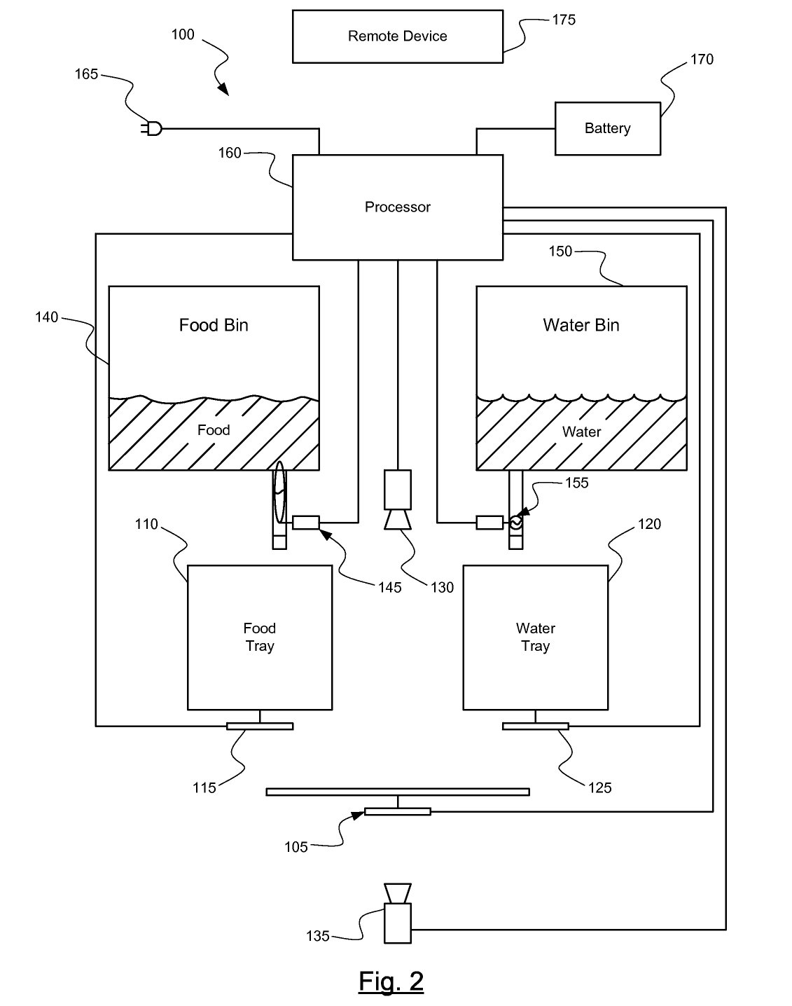

Turning now to FIG. 1, an axonometric view of one system 100 of the invention is shown. FIG. 2 shows a block diagram of system 100. Not all components may be visible on either FIG. 1 or FIG. 2. System 100 may include an animal scale 105, a food tray 110, a food scale 115, a water tray 120, a water scale 125, a facial camera 130, a monitoring camera 135, a food bin 140, a first means 145 for causing food from food bin 140 to be provided to food tray 110 (shown in FIG. 2 as a motor coupled with an auger), a water bin 150, a second means 155 for causing water from water bin 150 to be provided to water tray 120 (shown in FIG. 2 as an electronically actuated valve), a processor 160, a power connection 165 (i.e., for AC power from a wall socket), a battery 170 (i.e., for backup power when AC power fails), and a remote device 175. A cover 180 is also shown in FIG. 1 which has an aperture 185 designed to allow one animal at a time to use the feeder. Tops 190, 195 on food bin 140 and water bin 150 are also shown in FIG. 1.

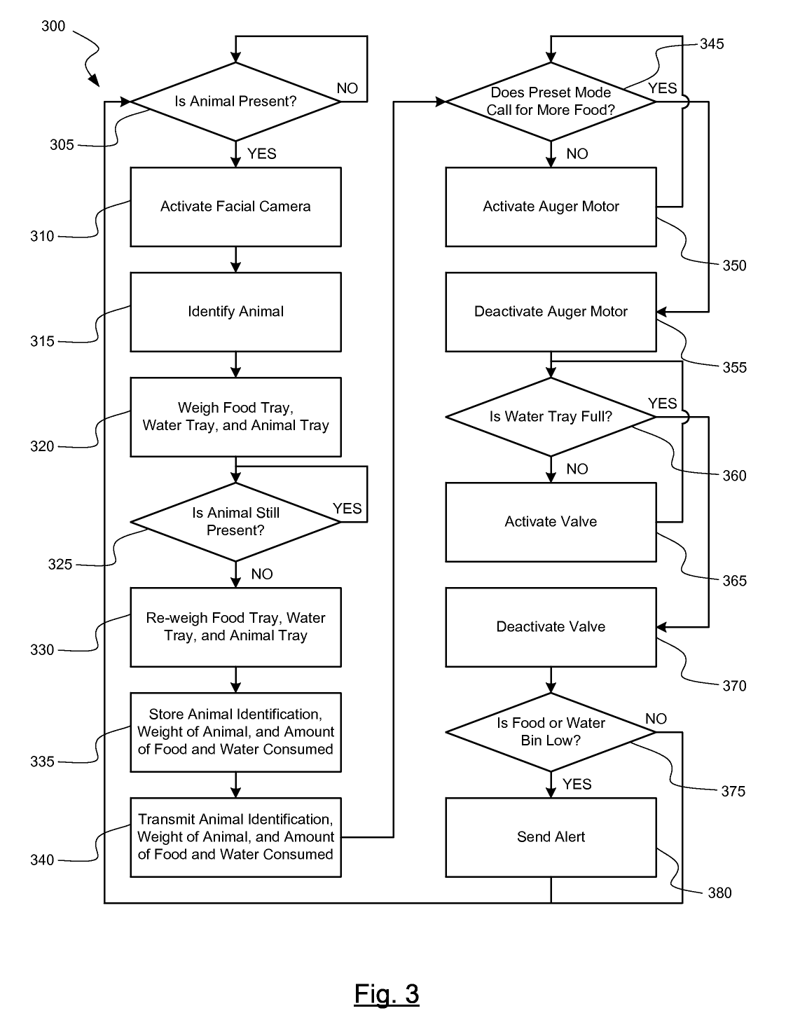

FIG. 3 shows a block diagram of one method 300 of the invention for operation of system 100. As discussed above, any of these operations may or may not occur in all different embodiments of the invention, they may occur in different orders, and/or concurrently.

At block 305, animal scale 105 is monitored to determine if an animal is present. In some embodiments, facial camera 130 and monitoring camera 135 may also be used to determine if an animal is present. Once an animal is detected, then at block 310, processor 160 activates facial camera 130. At block 315, based at least on an image from facial camera 130, processor identifies the animal. At block 320, food tray 110, water tray 120, and animal scale/tray 105 are weighed, and their values stored by processor 160 or other device. The animal then presumable eats and/or drinks for a period of time (also referred to herein as a “session”). At block 325, method 300 monitors using animal scale 105 and/or other devices to determine when the animal is no longer present (i.e., done feeding/drinking).

At block 330, food tray 110, water tray 120, and/or animal scale/tray 105 are re weighed. In other embodiments this re-weighing may happen continuously, with any drops in weight of the food tray 110 and/or water tray 120 also being recorded in a continuous manner. At block 335, processor 160, stores and or consolidates animal identification, weight of animal, and amount of food/water consumed information for transmission to remote device 175.

At block 345, method 300 checks for whether a preset mode, as set by a user, calls for more food to be available to the animal. A user, possibly via an interface provided at a mobile or other device, may define a preset mode which instructs processor 160 and/or remote device 175 how much food a certain animal is allowed to receive. For example, in one preset mode, perhaps called “buffet mode,” system 100 may refill food tray 110 whenever it is empty or nearly empty as indicated by food scale 115. In another example, in another preset mode, perhaps called “divide mode,” system 100 may refill food tray 110 in certain increments to provide a set amount of food in timed increments per hour/clay/week, etc. In yet another example, in another preset mode, perhaps called “hack mode,” system 100 may refill food tray 110 according to a custom schedule input by the user. In each of the aforementioned modes, or other modes, food may only be provided based upon which identified animal is present at the feeder. In this manner, different modes may be applied for different animals, as specified by a user. In another aspect, system 100 may also have a “backup mode” that upon any critical malfunction, such as a power failure, food tray 110 may be continuously refilled regardless of the mode set by the user.

If more food is called for, then at block 350, auger motor 145, or other means, may be activated by processor 160 to cause food to be provided from food bin 140 to food tray 110. Once filling of food tray 110 is complete, auger motor 145 is deactivated at block 355 (if additional food was not required, auger motor 145 is never activated and remains deactivated).

At block 360, method 300 checks for whether additional water is needed in water tray 120. Though in some embodiments a user could specify how much and when water is provided to a certain animal, in many embodiments the amount of water provided to animals may not be limited, and water will be replenished whenever water tray 120 is below a predefined level. If water is required, then at block 365 the electrically actuated valve 155 is actuated until the water tray is full. Once filling of water tray 120 is complete, valve 155 is deactivated at block 370 (if additional water was not required, valve 155 is never actuated and remains closed).

At block 375, perhaps via monitoring camera 135, processor 160 determines if food or water levels are low in food bin 140 or water bin 150. If not, then method 300 returns to block 305 to await another feeding/watering session. If food or water levels are low, then at block 380, processor 160 causes an alert to be sent to a user's mobile or other device via remote device 175, and method 300 returns to block 305 to await another feeding/watering session.

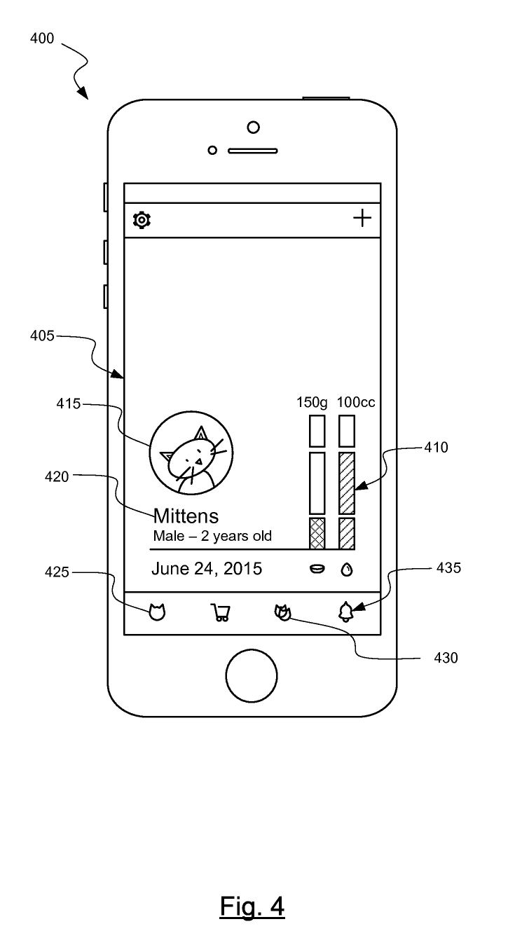

FIG. 4 shows a remote device 400 (shown in this example as a mobile phone) which displays one possible interface 405 of the invention. Interface, 405 may communicate with processor 160 and/or remote device 175 to allow a user to see how much food and water a given animal has consumed 410, perhaps relative to how much they should consume (consumed shown in hashed bars, anticipated/expected diet shown in empty bars). Interface 405 may show a picture 415 and name 420 of the animal, as well as other biographical information. More information on a specific animal may be provided by selecting icon 425 and calling up another interface. For example, history of an animal's usage of system 100, including their consumption of food/water over time may be displayed, as can the animal's weight. Selecting icon 430 may allow for similar information as described above to be provided for another animal of the user. Icon 435 may allow a user to set alert conditions for when to inform them of certain events such as when the animal is using system 100, or when eating/drinking habits of an animal exceed or fail to meet certain preset ranges, or when an animal's weight. Another interface on mobile device 400 may allow a user to set all ranges and amounts discussed herein regarding food/water and animal weight.

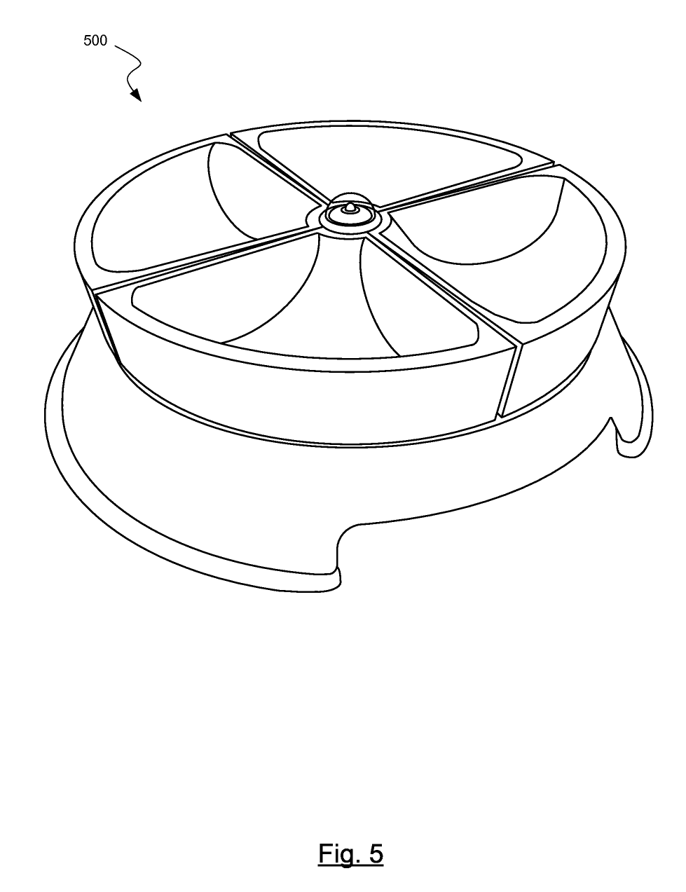

FIG. 5 shows another embodiment 500 of the invention in which 360° access to feeding trays is provided. Each of the four trays has an associated scale underneath it to determine how much food is eaten from each tray. To determine which animal is eating food in a given session at each tray, a 360° camera at the center of the embodiment 500 uses facial recognition algorithms to determine which animal is eating at which tray for each animal's session. In some embodiments, water may be provided in some of the trays. This information may be stored and used in the same manner as described above with regard to other embodiments.

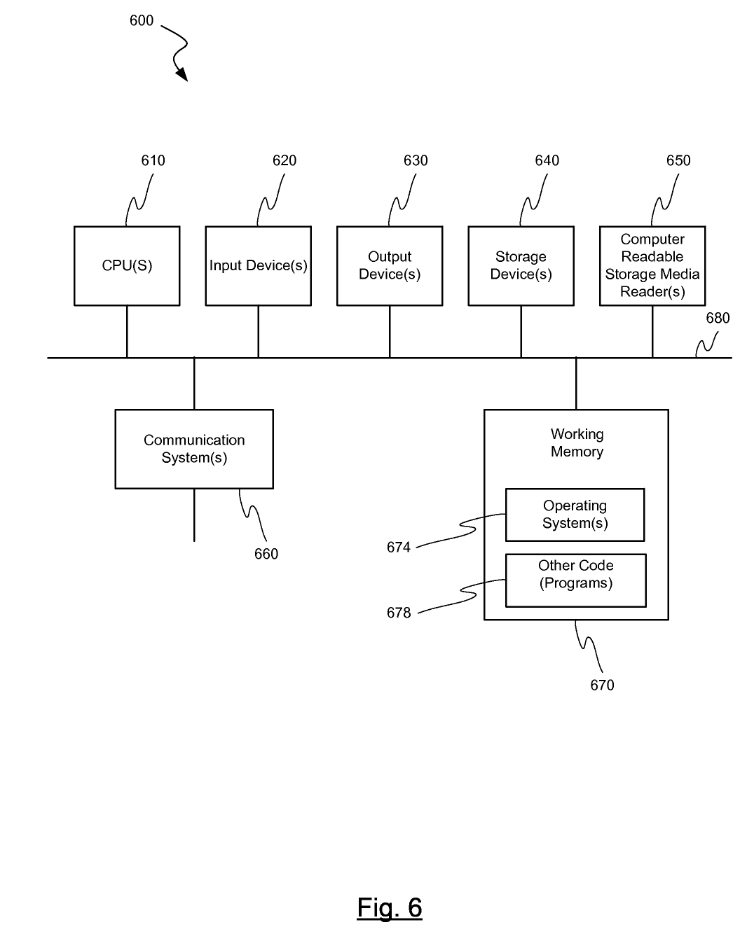

FIG. 6 is a block diagram illustrating an exemplary computer system 600 in which embodiments of the present invention may be implemented. This example illustrates a computer system 600 such as may be used, in whole, in part, or with various modifications, to provide or control the functions of the processor, the facial camera, the monitoring camera, the motor and auger, the valve, and/or other components of the invention such as those discussed above. For example, various functions of the processor may be controlled by the computer system 600, including, merely by way of example, communicating with the animal scale, the food scale, the water scale, and the facial camera, causing activation of the facial camera, determining an identity of the animal, determining that the animal has left the animal scale, determining an amount of food consumed by the animal, determining an amount of water consumed by the animal, causing information to be transmitted to a remote device, etc.

The computer system 600 is shown comprising hardware elements that may be electrically coupled via a bus 690. The hardware elements may include one or more central processing units 610, one or more input devices 620 (e.g., a mouse, a keyboard, etc.), and one or more output devices 630 (e.g., a display device, a printer, etc.). The computer system 600 may also include one or more storage device 640. By way of example, storage device(s) 640 may be disk drives, optical storage devices, solid-state storage device such as a random access memory (“RAM”) and/or a read-only memory (“ROM”), which can be programmable, flash-updateable and/or the like.

The computer system 600 may additionally include a computer-readable storage media reader 650, a communications system 660 (e.g., a modem, a network card (wireless or wired), an infra-red communication device, Bluetooth™ device, cellular communication device, etc.), and working memory 680, which may include RAM and ROM devices as described above. In some embodiments, the computer system 600 may also include a processing acceleration unit 670, which can include a digital signal processor, a special-purpose processor and/or the like.

The computer-readable storage media reader 650 can further be connected to a computer-readable storage medium, together (and, optionally, in combination with storage device(s) 640) comprehensively representing remote, local, fixed, and/or removable storage devices plus storage media for temporarily and/or more permanently containing computer-readable information. The communications system 660 may permit data to be exchanged with a network, system, computer and/or other component described above.

The computer system 600 may also comprise software elements, shown as being currently located within a working memory 680, including an operating system 684 and/or other code 688. It should be appreciated that alternate embodiments of a computer system 600 may have numerous variations from that described above. For example, customized hardware might also be used and/or particular elements might be implemented in hardware, software (including portable software, such as applets), or both. Furthermore, connection to other computing devices such as network input/output and data acquisition devices may also occur.

Software of computer system 600 may include code 688 for implementing any or all of the function of the various elements of the architecture as described herein. For example, software, stored on and/or executed by a computer system such as system 600, can provide the functions of the processor, the facial camera, the monitoring camera, the motor and auger, the valve, and/or other components of the invention such as those discussed above. Methods implementable by software on some of these components have been discussed above in more detail.

A number of variations and modifications of the invention can also be used within the scope of the invention. For example, XXX.

The invention has now been described in detail for the purposes of clarity and understanding. However, it will be appreciated that certain changes and modifications may be practiced within the scope of the appended claims.

What is claimed is:

1. A system for providing food to an animal, wherein the system comprises:
an animal scale for determining a weight of an animal on the animal scale;
a food tray for receiving food from a food bin;
a food scale for determining a weight of food in the food tray;
a water tray for receiving water from a water bin;
a water scale for determining a weight of water in the water tray;
a facial camera for observing a face of the animal when the animal is facing at least one of the food tray or the water tray;
a processor in communication with the animal scale, the food scale, the water scale, and the facial camera, for:
causing, upon a first change in weight being indicated by the animal scale, activation of the facial camera;
determining, based at least on the face of the animal observed by the facial camera, an identity of the animal;
determining, based upon a second change in weight being indicated by the animal scale, that the animal has left the animal scale;
determining, after the animal has left the animal scale, and based at least in part on the food scale, an amount of food consumed by the animal;
determining, after the animal has left the animal scale, and based at least in part on the water scale, an amount of water consumed by the animal; and
causing the identity of the animal, the amount of food consumed by the animal, and the amount of water consumed by the animal to be transmitted to a remote device.

2. The system for providing food to an animal of claim 1, wherein the system further comprises:
the food bin; and
the water bin.

3. The system for providing food to an animal of claim 1, wherein the system further comprises:
a monitoring camera for observing an amount of food in the food bin and an amount of water in the water bin.

4. The system for providing food to an animal of claim 3, wherein the processor is further for:
determining, based at least on the amount of food in the food bin or the amount of water in the water bin, whether to transmit an alert.

5. The system for providing food to an animal of claim 1, wherein the further for:
causing transmission of picture data or video data from the facial camera to a remote device.

6. The system for providing food to an animal of claim 1, wherein the system further comprises:
the remote device which includes a server for transmitting the picture data or video data to a mobile device.

7. The system for providing food to an animal of claim 1, wherein:
the system further comprises a first means for causing food from the food bin to be provided to the food tray; and
the processor is further for activating, based upon a third change in weight being indicated by the food scale, the first means.

8. The system for providing food to an animal of claim 7, wherein the first means comprises:
a motor coupled with an auger.

9. The system for providing food to an animal of claim 1, wherein:
the system thither comprises a first means for causing water from the water bin to be provided to the water tray; and
the processor is further for activating, based upon a third change in weight being indicated by the water scale, the first means.

10. The system for providing food to an animal of claim 9, wherein the first means comprises:
a valve.

11. The system for providing food to an animal of claim 1, wherein:
the processor is further for causing a weight of the animal, as determined based at least in part on the animal scale, to be transmitted to the remote device; and
the system further comprises the remote device which includes a server for storing at least one of the identity of the animal, the amount of food consumed by the animal, the amount of water consumed by the animal, or the weight of the animal.

12. The system for providing food to an animal of claim 11, wherein the server is further for causing transmission of at least one of the identity of the animal, the amount of food consumed by the animal, the amount of water consumed by the animal, or the weight of the animal to a mobile device.

13. The system for providing food to an animal of claim 1, wherein the processor determining the identity of the animal comprises:
the processor using facial recognition algorithms to compare a currently Observed animal to a previously observed animal.

14. The system for providing food to an animal of claim 1, wherein the processor determining the identity of the animal comprises:
the processor using facial recognition algorithms to differentiate a currently observed animal from a previously observed animal.

15. A system for providing food to an animal, wherein the system comprises:
an animal scale for determining a weight of an animal on the animal scale;
a food tray for receiving food from a food bin;
a food scale for determining a weight of food in the food tray;
a water tray for receiving water from a water bin;
a water scale for determining a weight of water in the water tray;
a facial camera for observing a face of the animal when the animal is facing at least one of the food tray or the water tray;
a processor in communication with the animal scale, the food scale, the water scale, and the facial camera, for:
causing, upon a first change in weight being indicated by the animal scale, activation of the facial camera;
determining, based at least on the face of the animal observed by the facial camera, an identity of the animal;
determining, based upon a second change in weight being indicated by the animal scale, that the animal has left the animal scale;
determining, after the animal has left the animal scale, and based at least in part on the food scale, an amount of food consumed by the animal; and
determining, after the animal has left the animal scale, and based at least in part on the water scale, an amount of water consumed by the animal.

16. The system for providing food to an animal of claim 15, wherein the system further comprises:
a monitoring camera for observing an amount of food in the food bin and an amount of water in the water bin.

17. The system for providing food to an animal of claim 16, wherein:
the monitoring camera is also for observing the animal; and
determining the identity of the animal is further based at least on an observation of the animal by the monitoring camera.

18. The system for providing food to an animal of claim 15, wherein the system further comprises:
a guard covering at least one of the food tray or the water tray, the guard having an aperture shaped to allow no more than one animal access the food tray or the water tray at a time.

19. A system for providing food to animal, wherein the system comprises:
a first means for recognizing a presence or an absence of an animal;
a food scale for determining a weight of food in a food tray;
a water scale for determining a weight of water in a water tray;
a facial camera for observing a face of the animal when the animal is facing at least one of the food tray or the water tray;
a processor in communication with the means for recognizing the presence of the animal, the food scale, the water scale, and the facial camera, for:
determining, upon a first indication from the first means that the animal is present, and based at least on the face of the animal observed by the facial camera, an identity of the animal;
determining, upon a second indication from the first means that the animal is absent, and based at least in part on the food scale, an amount of food consumed by the animal; and
determining, upon the second indication from the first means that the animal is absent, and based at least in part on the water scale, an amount of water consumed by the animal.

20. The system for providing food to an animal of claim 19, wherein the first means comprises:
an animal scale.
